(19) United States
(12) Patent Application Publication
(10) Pub. No.: US 2003/0014755 A1
(43) Pub. Date: Jan. 16, 2003

(54) Method and system for processing correlated audio-video segments with digital signatures within a broadcast system

(76) Inventor: Marvin Lynn Williams, Hickory Creek, TX (US)

Correspondence Address: Marvin Williams, 209 Woody Trail, Hickory Creek, TX, 75065, US

(21) Appl. No.: 09/905,124

(22) Filed: Jul. 13, 2001

(51) Int. Cl. H04N 7/025; H04N 7/10; H04N 7/16; H04N 7/20; H04N 7/173; H04Q 7/20

(52) U.S. Cl. 725/62; 725/68; 725/123; 455/454

(57) ABSTRACT

A method and apparatus for correlating the transmission of audio-video segments to digital signatures over a wireless or non-wireless medium to allow for real-time substitution and processing of audio and video programs. In one embodiment at least one digital signature having a correlated audio-video segment is transmitted as a digital waveform within an analog modulated signal representing the audio-video segment. The analog modulated signal is transmitted to a wireless receiver. The wireless receiver demodulates the digital waveforms while concurrently playing the correlated audio-video segment. An electronic user interface enables the wireless receiver to define conditional preferences to actively scan a plurality of channels and Internet addresses to substitute a currently playing audio-video segment with a preferred audio-video segment. In an alternative embodiment, a distributed computer network is the broadcast system transmitting digital signatures to either a wireless or non-wireless computer.

### TECHNICAL FIELD OF THE INVENTION

The present invention relates to transmission and reception of broadcast signals and more particularly to a method and apparatus for correlating digital signatures to video frames and/or audio segments to create conditionally defined preferences. The invention is especially concerned with a method and apparatus for correlating the transmission of audio and video segments with a set of digital signatures over a wireless or non-wireless medium to allow for real-time substitution and processing of audio and video programs.

In one illustrative aspect, the invention concerns a mobile wireless receiver capturing digital signatures to create a set of listening and viewing preferences based on conditional preferences. In an alternative embodiment the invention uses a distributed computer network as the transmission medium. In this alternative embodiment the receiver is either a wireless or non-wireless computing device capturing the set of digital signatures to allow a user to define at least one conditional preference.

### BACKGROUND OF INVENTION

In recent years the quality of commercial audio and video broadcasts has been eclipsed by the quality of stored digital information, such as compact discs (CDs), digital versatile disks (DVDs) and digital audio tapes (DATs). A number of systems have been developed for transmission and reception of digital audio and digital video signals. Prior art has generally focused on the fidelity and quality of the sound delivered to compatible receivers. More recent methods have focused on the delivery of digitized audio within the FM band channel, In-Band On Channel (IBOC) as well as adjacent frequencies between In-Band Adjacent Channel (IBAC). In addition to delivering an analog source program in the form of digital representation these systems are known to deliver auxiliary data. An example of auxiliary data has included stock quotes, news, sports information, and subscriber specific information. Auxiliary data can be transmitted via traditional broadcast channels or on Subsidiary Communication Authorization (SCA) bands. For example, U.S. Pat. No. 5,262,860 describes a method of capturing visually perceptible data from a video signal to perform automatic telephone dialing. Unfortunately, this method requires a visual perception of the data and does not address reception of the data based on conditional situations. Thus different techniques are known for transmitting data over subcarries in various broadcast systems. Despite these advances in the ability to receive and capture data within a broadcast system, these advances have not addressed real-time program substitution based on a user's preference to specific audio and video segments.

Users often encountered a problem of finding their listening and viewing preferences among a plurality of channels in existence. Recent scan and seek buttons have allowed users to search among a set of channels for a user preferred audio-video segment. An audio-video segment is defined as any logical or coherent group of audio segments and/or video frames, such as a song, movie, stock quote, talk show, etc. The audio-video segment is thus further defined to contain isochronous data, i.e., time based-streamed data, such as audio, video or animation. A digital signature is defined to be a self-descriptive informational construct that is non-isochronous in form. Current seek and scan buttons do not guarantee a current playing of a user's listening and viewing preferences. Moreover, a user may discover a preferred broadcast program only after it has been partially completed; e.g. the song is half way over. More recent systems have allowed users to search a pre-defined database of broadcast programs and notify a user of upcoming programs. The predefined database approach is based on a publisher creating the predefined database and does not address the problem of replacing a currently playing broadcast program based on user preferences. Publisher created pre-defined databases have an inherent problem of forcing a user to access and search according to predefined characteristics and rules of the database publisher. In addition, a user's preferred listening and viewing preferences may not even be registered within the pre-defined database. Users desire the ability to define their own characteristics for finding a preferred viewing or listening preference.

Other prior art has the ability to preprogram channels, but lack the ability of automatically substituting a currently playing audio-video segment based on a users own constructed conditional expression. A conditional preference is defined as a conditional expression with an associated action. U.S. Pat. No. 6,198,509, “Method and apparatus for providing and receiving broadcaster information”, by Dougherty et al. addressed an interactive information system for storing broadcaster identifications associated with a channel, but failed to addressed the problem of defining and programming preferred viewing and listening characteristics based on conditional preferences. Moreover, U.S. Pat. No. 6,198,509 fails to address the problem of multiple audio-video segments in a single broadcast program of which only one audio-video segment or set of audio-video segments are of interest to a user. This prior art and many others has inherently developed request-response approaches of interaction within the same transmission medium, e.g., an interactive cable TV provides information over cable and a user responds over cable. Users desire mechanism whereby they can get the information over cellular phones, Personal Digital Assistants, pagers and the like and have these devices control other reception and transmission mediums, such as radio, or television or the Internet based on their conditional preferences.

A viewing or listening preference may be of commercial or geographical nature, such as a sales promotion or directions to a location. Users often desire substitution of audio-video segments based on preferred geographical locations relative to their movement or their personal financial position. Under such conditions users desire the ability to respond or gather supplemental information based on a user's conditional preference. A method and apparatus that addresses these desires and other advantages will be further appreciated as the following detailed description and related drawings are read.

### BRIEF DESCRIPTION OF DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a partially schematic block diagram of a broadcast system including Digital Correlator, Transmitter and Receiver components of the present invention.

FIG. 2 presents one embodiment of a block diagram of a digital signature used within the context of the present invention.

FIG. 3 is a flow process diagram illustrating correlation and transmission of a set of digital signatures to an audio-video segment within the context of the present invention.

FIG. 4 illustrates one embodiment of an electronic user interface for capturing digital signatures and creating conditional preferences in accordance to the principles of the present invention.

FIG. 5 is a flow process diagram illustrating the method associating a captured digital signature to a conditional preference in accordance to the principles of the present invention.

FIGS. 6-7 are flow process diagrams illustrating the method of processing conditional preferences for substituting a currently playing audio-video segment within the context of the present invention.

FIGS. 8-9 are flow process diagrams illustrating the method of processing commercial, geographical and ancillary operations based on conditional preferences within the context of the present invention.

FIG. 10 illustrates a block schematic diagram of an alternative embodiment of the present invention comprising a distributed computer network as the broadcast system with a first computer as the transmitter and a second computer as a receiver.

### SUMMARY OF INVENTION

It is one object of the present invention to provide an improved broadcast system.

It is another object of the invention to provide an improved system and method to dynamically correlate digital signatures to an audio-video segment at non-conflicting intervals for output to a digital distributing device.

It is yet another object of the invention to provide an improved system and method associating a captured digital signature to a conditional preference.

It is yet another object of the invention to provide an improved system and method for selectively seeking and substituting preferred audio-video segments within a broadcast system for playing and recording.

It is yet another object of the invention to provide an improved system for capturing and processing electronic commerce information over a broadcast system.

It is yet another object of the invention to provide an improved system and method for capturing and interpolating global positioning satellite information with digital signatures over a broadcast system.

It is yet another object of the invention to provide an improved system and method for communicatively coupling conditional preferences correlated to audio-video segments between multiple devices.

### DETAIL DESCRIPTION OF THE PREFERRED EMBODIMENTS

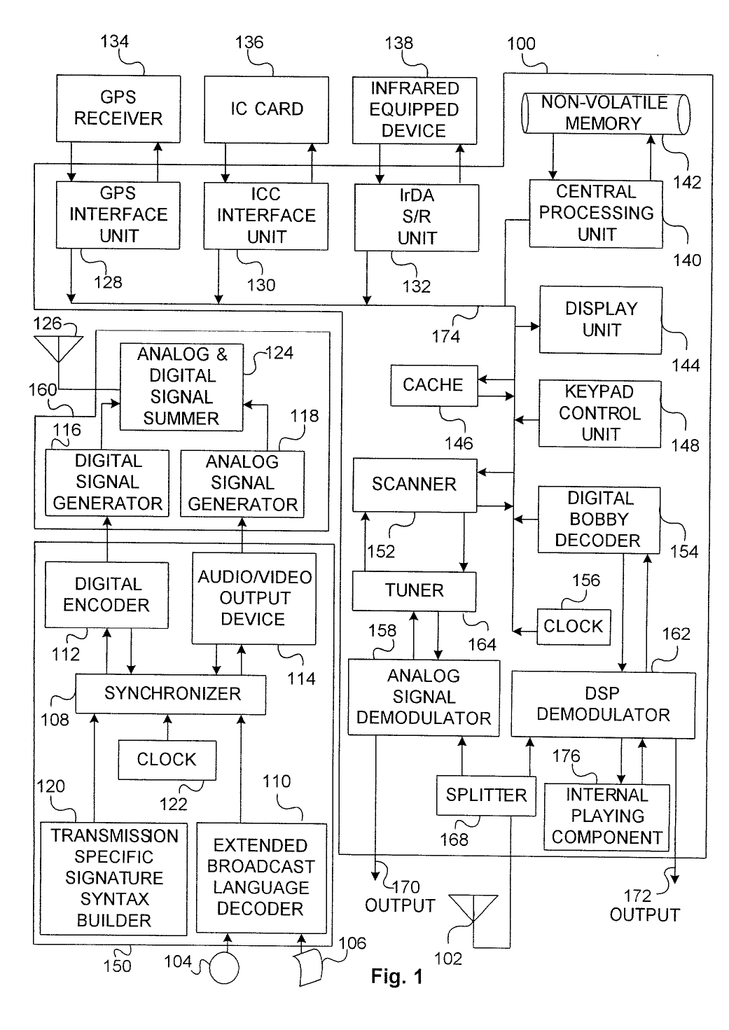

With reference now to the drawings and in particular with reference to FIG. 1, there is depicted a schematic pictorial representation in which like reference numerals indicate like parts of a system to implement the present invention. Included in FIG. 1 are a Digital Correlator 150, a transmitter 160 and a wireless receiver 100. The wireless receiver 100 can be a mobile radio, a Personal Digital Assistant (PDA), a pager, a television or a cellular phone and the like. In the preferred embodiment, Digital Correlator 150 has digital and analog processing capabilities having at least one language decoder correlating the output of at least one digital signature to an audio-video segment duration of time. The audio-video segment duration of time is defined as a playing time for an audio-video segment. When multiple digital signatures and audio-video segments are involved for correlation, Digital Correlator 150 correlates multiple digital signatures to multiple audio-video segment duration of times.

A storage medium is transcribed with an electronic document 106 defining the correlation and sequencing of at least one digital signature to the audio-video segment duration of time for input into the language decoder. Preferably, Synchronized Multimedia Integration Language (SMIL) describes sequencing of a digital signature 200 having a correlated audio-video segment within electronic document 106, however other languages and formats such as Extensible Mark-Up Language (XML), Standard Generalized Mark-Up Language (SGML), Wireless Mark-Up Language (WML), Hyper Text Mark-Up Language (HTML) and Compact Hyper Text Mark-UP Language (C-HTML) are applicable to the scope of the invention.

At least one language decoder decodes digital signature 200 and the audio-video segment from the storage medium containing electronic document 106 if present. In the preferred embodiment, the language decoder is an Extended Broadcast Language Decoder 110 component capable of processing electronic document 106 transcribed preferably in SMIL, however, XML, SGML, WML, HTML, C-HTML are applicable nomenclature for electronic document 106.

Digital signature 200 specifies informational status data, logical conditional expressions and/or associated actions to be correlated with transmitted video frames and audio segments. This specification of digital signature 200 is called a Basic Operational Binary Byte Yield, herein referred as a BOBBY and is interchangeable used to identify a digital signature. In the preferred embodiment the content of a BOBBY is defined in an XML format.

If electronic document 106 is not present then Extended Broadcast Language Decoder 110 decodes digital signature 200 and a correlated audio-video segment from a disk 104. After decoding at digital signature 200 and the correlated audio-video segment, Extended Broadcast Language Decoder 110 associates at least one digital signature transmission time with at least one audio-video segment duration of time. The digital signature transmission time is defined as an instance and duration of time for outputting a digital signature for the purposes of outputting a digital signature or data streaming digital signature 200. In the preferred embodiment, Extended Broadcast Language Decoder 110 determines an elapsed number of seconds from the beginning of the audio-video segment to the end of the audio-video segment as the audio-video segment duration of time to be used as input into a Synchronizer 108. Synchronizer 108 receives timing information from a timing device to determine a non-conflicting transmission time for digital signature 200 within the audio-video segment duration of time. Synchronizer 108 has means for outputting digital signature 200 to a digital distributing device. Synchronizer 108 outputs digital signature 200 to Digital Encoder 112 within the audio-video segment duration of time. Synchronizer 108 receives at least one digital signature from at least one language decoder, preferably Extended Broadcast Language Decoder 110. In the preferred embodiment the timing device is a clock 122 wherein Synchronizer 108 activates Audio/Video Output Device 114 for playing the audio-video segment and determines a remaining number of seconds from clock 122 to coincide the outputting of digital signature 200 to Digital Encoder 112 with the playing of the audio-video segment.

Alternatively, the audio-video segment duration of time can be derived from a start time and a stop time of the audio-video segment or from event notifications of start and stop of the audio-video segment without departing from the scope of the invention. In an alternative embodiment, the timing device is Audio/Video Output Device 114 sending a start signal to begin playing of the audio-video segment and a stop signal at the end of playing the audio-video segment to Synchronizer 108. In this alternative embodiment Synchronizer 108 outputs digital signature 200 to Digital Encoder 112 to coincide between the start signal and the stop signal.

Moreover, Synchronizer 108 correlates a set of digital signatures as identified within electronic document 106 or formatted on disk 104 to be outputted at non-conflicting transmission times during the playing of the audio-video segment. Synchronizer 108 determines a non-conflicting digital transmission time for each digital signature within a set of digital signatures. A non-conflicting digital signature transmission time is defined as period of time that does not conflict with any other digital signature transmission time. Given modern day components and processing capabilities these non-conflicting digital signature transmission times may exist for seconds or milliseconds while playing the audio-video segment. Synchronizer 108 outputs each digital signature into Digital Encoder 112 by identifying an available time slot for each digital signature within the audio-video segment duration of time. Synchronizer 108 sends each digital signature at the non-conflicting digital transmission time. The set of digital signatures may contain members that are identical, i.e., a single digital signature being continuously sent to Digital Encoder 112 while Audio/Video Output Device 114 plays the audio-video segment. Synchronizer 108 ensures no interference or cross stepping between digital signatures being transmitted during the audio-video segment duration of time. Synchronizer 108 dynamically synchronizes and correlates multiple digital signatures to the audio-video segment at non-conflicting intervals of time while transmitting, playing, recording, or data streaming the audio-video segment.

In another embodiment of the invention, the language decoder is a Transmission Specific Signature Syntax Builder (TSSSB) 120 capable of dynamically processing a real-time broadcast digital signature. The real-time broadcast digital signature is defined as a digital signature generated and introduced during the actual transmitting, playing, recording or data streaming of the audio-video segment. The real-time broadcast digital signature can include station identifier, time that the audio-video segment will be transmitted again, commercial information, transmission frequency, alternate Internet address, musical category of a station and the like. Preferably the real-time broadcast digital signature is transmission specific data correlated to a currently playing audio-video segment although this need not be the case. In the preferred embodiment, TSSSB 120 dynamically outputs the real-time broadcast digital signature into Synchronizer 108 to determine a non-conflicting transmission time for the real-time broadcast digital signature during the audio-video segment duration of time. TSSSB 120 is comprised of a Graphical User Interface allowing users to dynamical associate real-time broadcast digital signatures with the currently playing audio-video segment. A serial interface from TSSSB 120 outputs at least one real-time broadcast digital signature into Synchronizer 108. Alternatively, TSSSB 120 outputs a plurality of real-time broadcast digital signatures. Parallel and other digital interfaces are also applicable as a replacement for the serial interface component. TSSSB 120 formats and sends the real-time broadcast digital signature through the serial interface for processing by Synchronizer 108. Synchronizer 108 again ensures no interference or cross stepping on the transmitting, playing, recording, or data streaming between any digital signatures. For example, a broadcaster may wish to advertise that a currently playing song on disk 104 may be purchased at a specific store. Synchronizer 108 synchronizes and correlates an advertiser specific digital signature for the song during transmission without conflicting with other transmitting digital signatures.

Synchronizer 108 activates Audio/Video Output Device 114. Additionally, real time audio and video may be generated from Audio/Video Output Device 114 such as through a microphone (not shown). Audio/Video Output Device 114 outputs an analog signal to transmitter 160. In the preferred embodiment, transmitter 160, contains analog and digital processing capabilities and functions as an analog input device and as a digital distributing device for transmitting on a transmission medium at least one transmission instance of a digital signature correlated to at least one audio-video segment. Transmitter 160 comprises an Analog Signal Generator 118 receiving the analog signal from Audio/Video Output Device 114. Digital Encoder 112 encodes digital signature 200 outputted from Synchronizer 108 as a digital signal for output to the digital distributing device within the audio-video segment duration of time. In the illustrative embodiment the digital distributing device is transmitter 160 comprising of a Digital Signal Generator 116. Transmission of the digital and analog signals can occur through a wireless or non-wireless medium.

The invention executes a novel feature of dynamically adding personal or system generated digital signatures in a non-conflicting manner to pre-existing digital signatures having the correlated audio-video segment for output to a digital distributing device.

Alternate digital distributing devices include a CD-ReWritable device, a stand-alone computer, a distributed network computer, a MP3 player, a DVD player/recorder, a videocassette recorder or a digital cam-recorder. For example, a user may desire to add personal editorial digital signatures correlated to an audio-video segment, thus using output from Digital Correlator 150 to write a CD. In the preferred embodiment, Digital Encoder 112 supports data in a Program Associated Data (PAD) format including support of Fixed-PAD (F-PAD) and extended transport formats, such as Mixed Object Data (MOD) for broadcasting by transmitter 160. Alternative embodiments include the transmission and reception over the transmission medium wherein the transmission medium is a television broadcast band, a cable broadcast band, a digital satellite signal, a distributed computer network, and a Wireless Application Protocol (WAP) medium.

Digital Signal Generator 116 performs digital baseband processing, forward error correction signal coding, modulation and related digital signal processing functions for transmitting the digital signal. Analog Signal Generator 118 within transmitter 160 processes the analog signal from Audio/Video Output Device 114. The analog signal from the Analog Signal Generator 118 and the digital signal from Digital Signal Generator 116 are summed together in a Summer 124 to form a composite modulated signal. In the preferred embodiment, Summer 124 has a Coded-Orthogonal-Frequency-Division-Mulitplexer (COFDM) encoder and modulator that combines the analog and digital signals. Summer 124 functions as a modulator or exciter, performing as a local oscillator, upconverter, signal formatter and linear amplifier, for the combined analog and digital signals.

Transmitter 160 broadcasts both an analog frequency transcribed with a transmission instance of digital signature 200 having a correlated audio-video segment. The analog signal may be modulated via frequency, FM, amplitude, AM, or a plurality of frequency degradation means including the following modulation means: Amplitude-Shift Keying (ASK), Frequency-Shift Keying (FSK), Phase-Shift Keying (PSK), Quadrature-Amplitude Modulation (QAM), and Differential Phase-Shift Keying (DPSK). Transmission standard Eureka 147 and the like are applicable transmission formats for the invention. Preferable, when used for broadcast to automobiles and the like, the digital signal and the analog modulated signal correspond in their content when demodulated by receiver 100 for listening or viewing by a user, although this need not be the case. The summed radio frequency (RF) from Summer 124 transmits a composite modulated/digital signal via an omnidirectional antenna 126. A conventional analog modulated receiver, a digital signal receiver, or a combination thereof may receive the composite modulated/digital signal. In one alternative embodiment transmitter 160 still transmits the analog signal, however Synchronizer 108 outputs the transmission instance of digital signature 200 on a differing transmission medium from the analog signal. In this alternative embodiment, the transmission instance of digital signature 200 contains a reference to the frequency or medium associated to the audio-video segment of the broadcast program. In this alternative embodiment the invention executes the novel feature of having Synchronizer 108 output to a digital distributing device that utilizes a different transmission medium then the audio-video segment.

A wireless receiver 100 having equipment for receiving and detecting at least one transmission instance of digital signature 200 having the correlated audio-video segment processes the transmission instance of digital signature 200 by a central processing unit (CPU) 140 with programmable stored instructions. It should be noted that the transmission instance of digital signature 200 might be a first instance of transmission or a subsequent instance of transmission for digital signature 200. Wireless receiver 100 receives the composite modulated/digital signal from a radio frequency (RF) carrier via a receiving omnidirectional antenna 102 the composite modulated/digital signal is divided into two paths by way of a splitter 168. Splitter 168 separates the reception of the digital signal summed with the analog signal, preferably as summed by transmitter 160. An Analog Signal Demodulator 158 interprets the composite modulated/digital signal and sends it to an audio-video output line 170 for audio and/or video reception. The digital signal from splitter 168 is directed toward Digital Signal Processor (DSP) demodulator 162 performing digital base band processing, forward error correction signal coding, modulation and related digital signal processing functions. DSP demodulator 162 outputs the digital signal to a digital output line 172, such as a digital audio and/or digital video and to a Digital BOBBY Decoder 154. Upon Digital BOBBY Decoder 154 detecting and decoding the transmission instance of digital signature 200. Digital BOBBY Decoder 154 sends the transmission instance of digital signature 200 over a data bus 174 to a programmable central processing unit 140, and to an onboard cache memory 146 and to a display unit 144. Display unit 144 receiving the transmission instance of digital signature 200 displays a textual description associated to the transmission instance of digital signature 200. The transmission instance of digital signature 200 is designated as a currently active digital signature with a currently playing audio-video segment.

Central processing unit 140 determines if the digital transmission instance has at least one conditional preference comprised of at least one conditional expression and an associated action. If the conditional expression evaluates to a true state then central processing unit 140 automatically initiates execution of the associated action.

Another novel feature of receiver 100 is permitting a user to define the captured digital signature with an associated interrupt-priority value. An electronic user interface 400 comprising a function control using keypad control unit 148 for associating at least a first captured digital signature from the currently active digital signature to at least one conditional preference. The invention provides a default conditional preference wherein central processing unit 140 with programmable stored instructions processes the default conditional preference by seeking a correlated audio-video segment having a higher interrupt-priority value than the interrupt priority value associated with the currently active video-segment and automatically substituting the currently playing audio-video segment with the correlated audio-video segment having the higher interrupt-priority value.

The default conditional preference comprises of the captured digital signature having an associated interrupt-priority value for subsequently seeking a frequency or Internet address referenced by a subsequent transmission instance of a digital signature having an higher interrupt-priority value than the interrupt-priority value correlated to the currently playing audio-video segment, i.e., the currently active digital signature. Upon finding a frequency and/or Internet address referenced by the subsequent transmission instance of digital signature 200 containing a higher interrupt-priority value, receiver 100 automatically selects the frequency or Internet address referenced by the subsequent transmission instance of digital signature 200 and substitutes the currently playing audio-video segment with the audio-video segment referenced by the subsequent transmission instance of digital signature 200.

In one conditional preference, a scanner 152 scans a plurality of frequencies seeking an adequate strength signal that contains a subsequent instance of the transmitted instance of digital signature 200 with the higher interrupt-priority value than the currently active digital signature. Upon scanner 152 detecting a subsequent transmitted instance of a digital signature having an higher interrupt-priority than the currently active digital signature, i.e. the currently playing audio-video segment, scanner 152 adjusts a tuner 164 for playing the audio-video segment associated to the subsequent transmitted instance of the captured transmitted instance of digital signature 200 via display unit 144 and speaker unit (not shown). Alternatively, IrDA Sending/Receiving Unit 132 sends out an appropriate infrared pulse signal code to adjust an external tuner (not shown) for an infrared equipped device 138. If the associate action of the conditional preference is receiver specific then wireless receiver 100 through its associated interfaces, including a Global Positioning Satellite (GPS) interface unit 128, an Integrated Circuit Card (ICC) interface unit 130 and an IrDA Sending/Receiving unit 132, performs specific receiver actions upon the conditional expression within the conditional preference evaluating to a logically true state.

The first captured digital signature and associated conditional preference can be derived from a capture of a broadcast transmission, as previously described or by manually entering the first captured instance of the conditional preference using keypad control unit 148. In addition, the conditional preference can be received through an Integrated Circuit (IC) Card 136, commonly known as a smart card or through infrared equipped device 138 or combination thereof.

Receiver 100 may receive a broadcast program with an audio-video segment having at least one transmission instance of digital signature 200 specifying geographical coordinates. For example, the geographical coordinates could convey retail store locations selling the currently playing audio-video segment. Central processing unit 140 evaluates conditional preferences having geographical base parameters within the conditional expression of the conditional preference. If the conditional preference having geographical evaluates to a true state then a GPS interface unit 128 reads GPS information from GPS receiver 134. This provides receiver 100 with means for interpolating geographical information from GPS interface unit 128 and geographical coordinates identified by the currently active digital signature and displaying geographical locations within electronic user interface 400. Preferably, GPS interface unit 128 receives and decodes GPS information in a National Marine Electronics Association (NMEA) format. NMEA 2000 specifically, although other formats and protocols are permissible without departing from the scope of the invention. GPS information received from GPS receiver 134 is sent to GPS interface unit 128 and sent over a data bus 174 to Central processing unit 140. Central processing unit 140 evaluates the conditional expression for interpolating geographical information from GPS interface unit 128 and the currently active digital signature containing geographical coordinates for displaying geographical locations and directions within electronic user interface 400. For example, the conditional preference may contain a complex logical expression such as notify a user with directions when the user is within a 2 mile radius of a store that contains a CD of a currently playing song. The geographical coordinates identified by digital signature 200 is decoded by Digital BOBBY Decoder 154 and displayed along with a user's current location as inferred by geographical information received from GPS interface unit 128. Keypad control unit 148 provides a function control to activate central processing unit 140 to store GPS information, directions and a graphical representation for subsequent viewing on an external display unit (not shown) using a non-volatile memory 142 as a storage medium.

Central processing unit 140 resolves the conditional preference in determining at least one associated action to be performed upon the conditional preference resolving to a logically true state. Central processing unit 140 resolves a time-based conditional preference by accessing a timing clock 156 to determine the current date and time. Central processing unit 140 resolves a conditional preference having geographical conditions by accessing the GPS interface unit 128 to determine current geographical location as delivered from GPS receiver 134. A conditional preference that resolves to display information is shown via display unit 144. A conditional preference resolving to play audio information can be heard via a speaker (not shown). Optionally, display unit 144 transfers information to be displayed and/or heard directly using an external device, (not shown) through audio-video output lines 170 and 172. This permits associated information to be displayed through the analog and digital systems as outputted on output lines 170 and 172.

A significant aspect of the invention is IrDA Sending/Receiving Unit 132 has infrared pulse length modulation capabilities for communicatively coupling receiver 100 to infrared equipped device 138, such as a television, a stereo-receiver, computer, radio and the like. Central processing unit 140 evaluating the conditional preference wherein the associate action of the conditional preference is to communicatively couple receiver 100 to infrared equipped device 138. Central processing unit 140 executes instructions to transmit at least one infrared command. Preferably, infrared commands from IrDA Sending/Receiving Unit 132 are encoded in RC5 and REC80 international standard codes. This significant aspect of the invention permits the action associated with a conditional preference to manipulate a plurality of infrared equipped devices. For example, upon receiver 100 receiving a digital signature activating a conditional expression to a logically true state receiver 100 substitutes a currently playing audio-video segment on an external infrared equipped television or radio, i.e. infrared equipped device 138.

Alternative embodiments include, upon the currently active digital signature being captured, a playable portion of the correlated audio-video segment is stored in non-volatile memory 142 for reference purposes. Other alternative embodiments include associating multiple conditional preferences to a single captured digital signature, associating a plurality of captured digital signatures to a single conditional preference as well as deriving the currently playing audio segment and associated interrupt priority value from an internal playing component 176.

Using internal playing component 176 to play the currently playing audio-video segment, DSP demodulator 162 demodulates the transmission instance for the currently active digital signature from internal playing component 176. Internal playing component 176 can be a disk player such as a CD-player or DVD player, as well as DAT player, cassette tape player, MP3 player and the like. Internal playing component 176 plays the currently playing audio-video segment having an associated interrupt-priority value. The currently playing audio-video segment is designated as the currently active digital signature having the associated interrupt priority value. As previously described, Digital Correlator 150 permitted for CD, DVD, computer disks, MP3 files, cassette tapes and the like to associate a digital signature to an audio-video segment having a corresponding interrupt-priority value. For example, a user may be listening to a song (an audio-video segment) on a CD with the associated interrupt-priority value recorded using Digital Correlator 150 while scanner 152 would be seeking a song having a higher interrupt priority value on other frequencies and Internet addresses.

Another alternative embodiment of the invention is the conditional preference is transferred bi-directionally between wireless receiver 100 and IC Card 136 (smart card). Additionally, the conditional preference is transferred bi-directionally between wireless receiver 100 and infrared equipped device 138. The conditional preference is stored in non-volatile memory 142 and sent over data bus 174 where ICC interface unit 130 using an EPROM connection encodes the conditional preference for transference to IC Card 136. Preferably information is exchanged with ICC interface unit 130 via a JAVA Card Application Programming Interface protocol that is ISO 7816-4 compliant, although alternate protocols are applicable without departing from the scope of the invention. Additionally, IrDA Sending/Receiving Unit 132 is communicatively coupled to infrared equipped device 138 to send at least one conditional preference to infrared equipped device 138 and receive the conditional preference from infrared equipped device 138. Conditional preferences from infrared equipped devices are transferred bi-directionally with Infrared Sending/Receiving Unit 132 preferably using an Infrared Data Association (IrDA) protocol. The conditional preference and a correlated audio-video segment reference in infrared equipped device 138 is transcribed over IrDA Sending/Receiving Unit 132 to central processing unit 140 and is stored in non-volatile memory 142. Those skilled in the art recognized that a plurality of infrared data transfer protocols and formats exist and could be incorporated by the invention without departing from the spirit and scope herewith.

Another alterative embodiment includes scanner 152 scanning specific channels or Internet addresses as identified in IC Card 136 or in onboard cache memory 146. Scanner 152 alternatively functions as an Internet connection socket to scan, receive and detect information over the Internet. An Internet Interface component (not shown), wireless or non-wireless, such as a Network Interface card or WAP compliant circuit component permits the invention to receive information from a distributed network to Digital Bobby Decoder 154 as described when the transmission medium is a distributed network.

In still another alternative embodiment, the storage medium is disk 104 defining correlation of digital signature 200 to audio-video segment and the audio-video segment duration of time. The preferred disk format for defining the correlation is a CD-ROM Mix Mode format. Additionally, CD-ROM XA, DVD-ROM, DVD-RAM, CD-I, CD-DA, CD-ReWritable, magnetic tape and other digital storage formats are applicable to the invention and provide means for storing and correlating a set of digital signatures to multiple audio-video segments without departing from the scope of the invention. Moreover, electronic document 106 may exist on the same or separate storage medium as the audio-video segment(s). For example, the audio-video segment may be stored on disk 104 while a correlated digital signature is identified within electronic document 106 is on a separate storage medium.

While several specific embodiments of the principles of the present invention are illustrated in the accompanying drawings and described in detail in the above specifications, it is to be understood that changes may be made without departing from the scope and spirit of the present invention. The scope of the present invention is not limited to specific frequency bands and carrier frequencies or transmission mediums set forth above. Also it is to be understood that the present invention is not limited to the particular semiconductor circuits used in the preferred embodiment. Integrated circuits such as described in the above specification or discrete components can be used to perform various functions in the block diagrams. These and other modifications may be made by one of ordinary skill in the art without departing from the principles of the present invention.

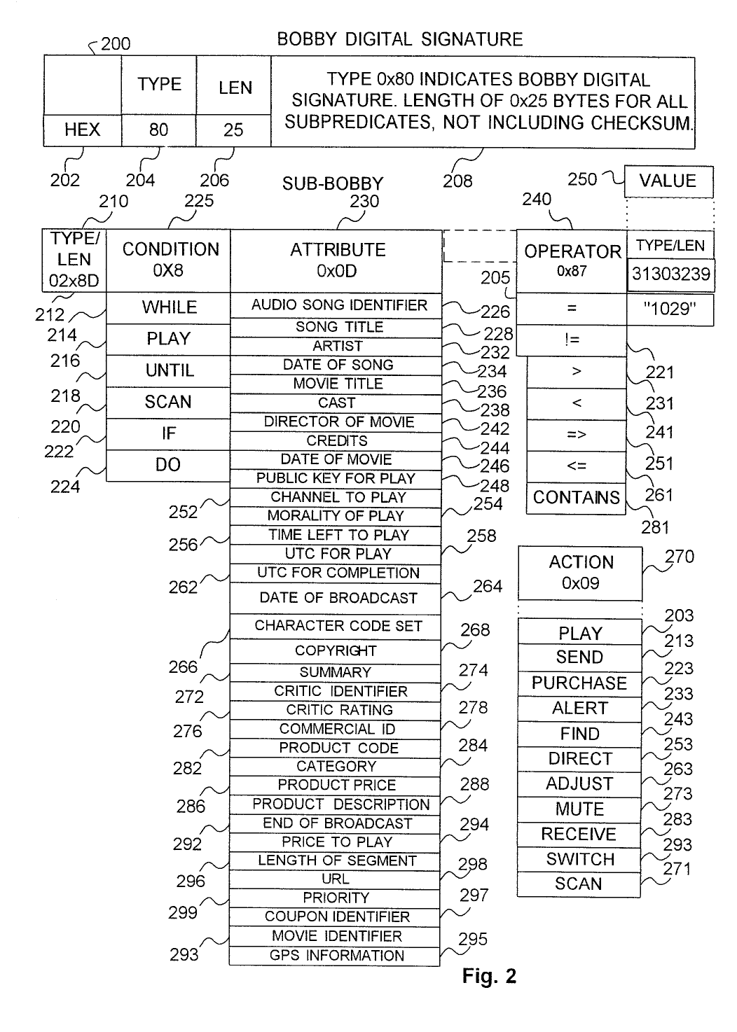

Turning now to FIG. 2 is a block diagram illustrating a digital signature 200 referred to as a BOBBY. Digital signature 200 exists in two basic formats. One format is an informational format used to convey information about the audio-video segment of a broadcast program, but the information need not be related to the broadcast program. A second format is a conditional preference format that describes at least one conditional expression associated to at least one action upon the conditional expression resolving to a logically true state. Although these formats are illustrated in the self-describing data object form in FIG. 2, they are preferably represented in an XML nomenclature when conveyed within a text document (not shown). Digital signature 200 illustrates a basic informational construct for a digital signature having a Type field 204 defining the type of BOBBY being conveyed, either informational or conditional preference format. Preferable informational format is used during transmission from transmitter 160 and the conditional preference format used upon capture of an informational formatted digital signature, although conditional formats may be also be transmitted within the context of the invention.

Length field 206 describes the length of the BOBBY in hexadecimal notation, not including a checksum. Expression Field 208 contains an expression descriptor that identifies the content of the information or conditional expression for the conditional preference. A detail break out of the expression field 208 is shown in expression descriptor 210. Length field 212 contains the type and length of the conditional expression. Attribute field 230 describes attribute information on related to the audio-video segment.

Attribute information can be on information directly related or not to a correlated audio-video segment of the broadcast program. Each attribute is identified by a unique hexadecimal value. The attribute field is identified within the transmission instance of digital signature 200 being transmitted by transmitter 160, thus identifying digital signature 200 with the attribute.

Attributes specified include: Audio Song Identifier 226 to uniquely identify a song correlated to the audio-video segment. Song Title 228 identifies the title of the song to the correlated audio-video segment. Artist 232 identifies the artist of the correlated audio-video segment. Date of Song 234 identifies a date of creation or original publication of the correlated audio-video segment. Movie title 236 identifies the title of a movie of the correlated audio-video segment. Cast 238 identifies a set of cast members of the correlated audio-video segment. Director of Movie 242 identifies a set of directors of the correlated audio-video segment. Credits field 244 identifies credits of the correlated audio-video segment. Date of Movie 246 identifies a date of a movie of the correlated audio-video segment. Public Key for Play 248 identifies a public key when used with a private key permits decoding of specific isochronous and/or digital signature information for the correlated audio-video segment. Channel to Play 252 identifies a channel transmitting the correlated audio-video segment. Morality of Play 254 identifies a moral content nature and recommendation, such as PG-13, to the correlated audio-video segment. Time left to Play 256 identifies number of seconds remaining for completion of the correlated audio-video segment. UTC for Play 258 identifies a Coordinate Universal Time for start time and date of the correlated audio-video segment. UTC for Completion 262 identifies a Coordinated Universal Time at which the correlated audio-video segment will finish. Character Code Set 266 identifies a character code set of fields within digital signature 200. Copyright Information 268 identifies copyright date and rights information for the correlated audio-video segment. Summary 272 identifies an abstract summary associated to the correlated audio-video segment. Critic Identifier 274 identifies a set of critics for the correlated audio-video segment. Critic rating 276 identifies a 5 star ranking value given by a critic as identified within the Critic Identifier 274 field associated to the correlated audio-video segment. Commercial Identifier 278 uniquely identifies a commercial for the correlated audio-video segment. Product Code 282 identifies a specific product having a universal bar code for the correlated audio-video segment. Category field 284 identifies a category for the correlated audio-video segment, such as jazz, country, polka, rock, and rap. Product Description 288 identifies a text description of a specified product for the correlated audio-video segment. Product Price 286 identifies a price of a specified product correlated to the audio-video segment.

End of Broadcast 292 identifies a flag to designate the end of the correlated audio-video segment. Price to Play 294 identifies a monetary price to play or access the correlated audio-video segment. Length of Segment 296 identifies a length in seconds of the correlated audio-video segment. URL 298 identifies at least one Universal Resource Locator for the correlated audio-video segment that permits manual or automatic navigation within a distributed network, such as the Internet. As previously described, Synchronizer 108 can alternatively output to a distributed network. URL 298 permits identification of a network address for data streaming. An Interrupt-priority field 299 identifies an ordinal value of preference for interrupting a currently playing audio-video segment. A user upon viewing or hearing the audio-video segment specifies the ordinal value or a default interrupt-priority value is automatically assigned upon the user requesting to capture a transmission instance of digital signature 200. A Coupon field 297 identifies electronic coupon and discount information associated with Product Code 282 of the correlated audio-video segment. The Coupon field allows a commercial entity to identify digital signatures as coupons for physical or electronic purchases. The invention allows a user to capture coupons for subsequent use via hearing or seeing the correlated audio-video segment of the broadcast program. Movie Identifier field 293 uniquely identifies a movie for the correlated audio-video segment. Global Positioning Satellite field 295 identifies geographical coordinates associated to the correlated audio-video segment. Alternatively, geographical coordinates are specified by Mobile Positioning Center (MPC) protocol, using a triangulation of at least three communication cells. Alternatively Global Positioning Satellite field 295 identifies a plurality of geographical coordinates associated to multiple locations. This information includes longitude, latitude, and altitude and optionally vectors describing a relative velocity.

A Value field 250 identifies an associated value for the attribute field 230. Value field 250 is identified by a unique hexadecimal number, followed by the length of the field, followed by a content descriptor. The content descriptor is alphanumeric in nature. A unique hexadecimal value in the Type portion of the Value field 250 identifies the alphanumeric type for the content descriptor. The length field describes the length in bytes of the content within Value field 250. A purely informational digital signature merely conveys fields 212, 230 and 250 within the expression field 208.

As previously described digital signature 200 may contain a conditional expression, in such cases, a Conditional field 225 is conveyed along with Attribute field 230. The Conditional field 225 identifies types of conditions for initiating a specified action. Condition field 225 identifies itself and a type of logical condition. Types of logical conditions included and illustrated in FIG. 2 are: While 214 to allow for continuous actions while the conditional expression is true. Play conditional field 216 specifies a direct action to play the correlated audio-video segment unless specified with another condition, such as Until field 218. Until field 218 specifies continuous operation of an action until the specified conditional expression is resolved to a logically true state. A Conditional-If field 222 identifies an action to perform if the expression is true. A Conditional DO field 224 defines an action to be executed. A Conditional Scan 220 identifies a set of channels to scan while the expression is true. Alternatively, when the invention uses a distributed computer network medium, Conditional Scan 220 defines a set of URLs to Scan. The set of URLs are specified in Value field 250. A hexadecimal value greater than the frequency channel indicates to scan all channels while the condition is true.

Operator field 240 identifies an operational condition to evaluate the conditional expression. Operational conditions include: Equal 205, to evaluate if Attribute field 230 is equal to the value contained within the content of Value field 250. Not Equal 221 field evaluates if Attribute field 230 is not equal to the content in Value field 250. Greater Then field 231 evaluates if Attribute field 230 is greater than the value within the content in Value field 250. Less Than field 241 evaluates if Attribute field 230 is less than the value in the content of Value field 250. Greater Then or Equal 251 operator field evaluates if Attribute field 230 is greater than or equal to the content in Value field 250. Less Then or Equal 261 operator field evaluates if Attribute field 230 is less then or equal to the content in the Value field 250. A Contains 281 operator field evaluates if a specific value as defined within the content of the Value field 250 is contained within a set of digital signatures being received by receiver 100.

The Action field 270 identifies the associated action that is to be performed if the conditional expression is evaluated as true. When Action field 270 is combined within digital signature 200 with the expression descriptor 210 the BOBBY forms a conditional preference. Associated actions include but are not limited to:

Play Action 203, specifies to play the correlated audio-video segment. The audio-video segment could be played on internal playing component 176 or played on infrared equipped device 138 via IrDA Sending/Receiving Unit 138 sending appropriate infrared signal codes. The infrared equipped device can be a CD/DVD player/recorder, a cassette player, television or any other infrared equipped device. It should be noted that the Send Action 213 specifies to send information to a specific device, which is identified in the Value field 250. Purchase action 223 to purchase a specified item as contained within digital signature 200 or retrieved from non-volatile memory 142. The Alert field 233 specifies to alert a user when the expression is true. Alerts are be performed by audio or video using display unit 144 of FIG. 1. The Find action 243 specifies a directional mapping of a geographical location as received from receiver 100 within the currently active digital signature. Central processing unit 140 processes geographical information within digital signature 200 and marks a designated location in a map displayed on display unit 144. A Direct action 253 field initiates an action to display unit 144 to draw and converse directions from a designated location using GPS information derived from GPS unit interface 128 as delivered by GPS receiver 134. An Adjust field 263 specifies adjustments to equipment attributes as specified in the Value field 250. For example, the Adjust field 263 can adjust volume or bass for display unit 144 and output units 170 and 172. The Mute action field 273 specifies to mute the device as specified in the value field 250. The Receive action field 283 identifies ancillary specific operations for wireless receiver 100. The Switch action field 293 specifies to switch channels, frequencies, or Internet addresses upon the conditional expression resolving to a logically true state. The Scan Action field 271 specifies to execute a command to scan specific channels, frequencies or Internet addresses as specified in the Value field 250 upon conditional expression being true. It should be stated that a conditional preference default the conditional expression to a logically true state when a conditional preference only has an associated action. Thus it is permissible to state the action and value for immediate execution of the specified action.

A novel feature of the invention is digital signature 200 specification of electronic commerce information, specifically attributes: Commercial Identifier 278, Product Code 282, Product Description, 288, Price to Play 294, Product Price 286 and Coupon field 297. These attributes thus define electronic commerce information for the correlated audio-video segment for transmitter 160 to transmit and for receiver 100 to capture and construct conditional preferences based on a financial condition. The financial condition can be further assessed from information retrieved from IC Card 136 (smart card) via interface ICC interface unit 130.

Modifications of these self-descriptive informational constructs and additional fields with differing logical constructs and combinations may be made by one of ordinary skill in the art without departing from the principles of the present invention.

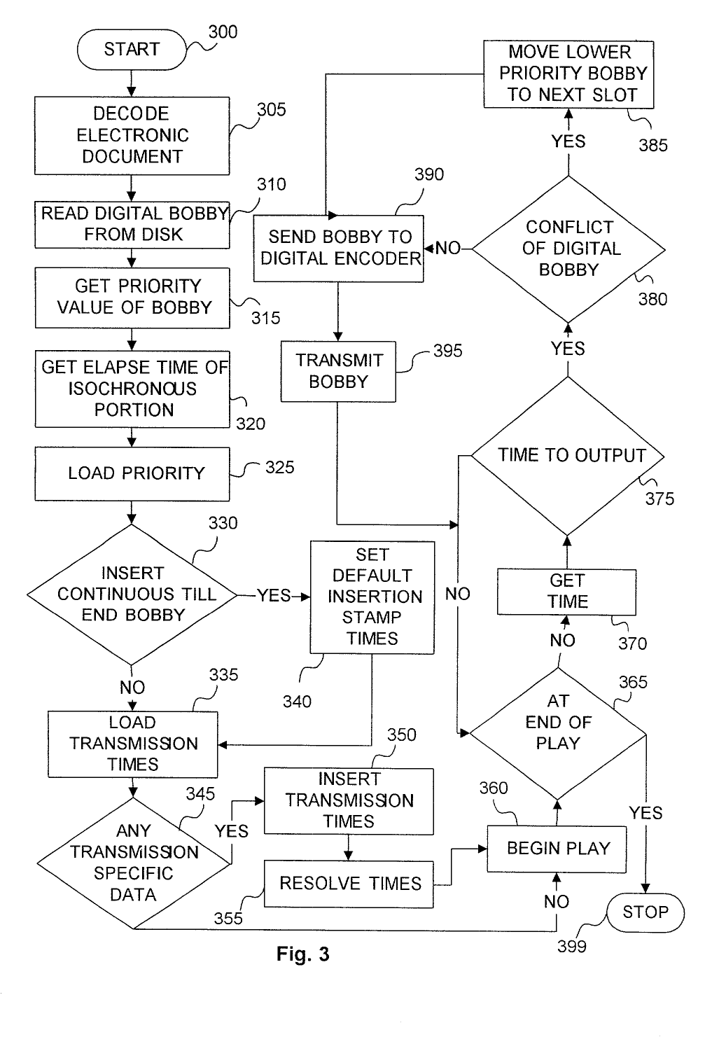

Turning now to FIG. 3, illustrated is a flow process diagram for correlating and transmitting a set of digital signatures to an audio-video segment during a broadcast program. The process starts at step 300 where initialization occurs for Digital Correlator 150. After initialization step 305, Extended Broadcast Language Decoder 110 decodes a correlation for the output of at least one digital signature to the playing of at least one audio-video segment. Extended Broadcast Language Decoder 110 reads a digital signature from disk 104 for processing in step 310. In the case of no electronic document 106, step 305 is a null process. After reading digital signature 200, step 315 evaluates the priority value of digital signature 200. It is important to note that the priority values being defined in process steps 315 and 325 are for prioritizing insertion and/or transmission of digital signatures and are not interrupt-priority values for interrupting a currently playing audio-video segment. Next step 320 reads total elapse time for the audio-video segment as specified in electronic document 106 or from disk 104 if electronic document 106 is not present. The elapse time is loaded into Time Left to Play field 256 of digital signature 200 and processed by Synchronizer 108 and is designated as an audio-video segment duration of time. Synchronizer 108 in step 325 loads a default priority value into digital signature 200 if no priority is specified for digital signature 200. Next decisional step 330 determines if digital signature 200 (BOBBY) is to be transmitted repeatedly while playing an audio-video segment. If digital signature 200 is scheduled for continuously to be outputted then step 340 determines a non-conflicting digital signature transmission time for repeatedly transmitting digital signature 200 (BOBBY) within the audio-video segment duration of time. Process step 340 determines a plurality of non-conflicting transmission times for continuously repeating transmission of digital signature 200 (BOBBY) while not conflicting with the transmission time of other digital signatures during the audio-video segment duration of time. Transmission times are compared in step 340 to ensure no cross stepping while repeatedly transmitting the set of digital signatures within the audio-video segment duration of time. After step 340 the process continues to step 335 where a non-conflicting transmission time is assigned to digital signature 200 (BOBBY). If there are no continuous digital signatures as determined from step 330 then the process continues once again to step 335 where non-conflicting transmission times for the set of digital signatures within the context of the audio-video segment are loaded into Synchronizer 108. Next decisional step 345 reads information from TSSSB 120 to determine if at least one real-time broadcast digital signature to be transmitted (outputted) during the audio-video segment, i.e., within the audio-video segment duration of time. If there is at least one real-time broadcast digital signature then the process continues to step 350 where Synchronizer 108 determines a non-conflicting transmission time for the real-time broadcast digital signature during the audio-video segment duration of time. After assignment of transmission times from step 350 the process continues to step 355 where priority values are resolved for digital signatures having conflicting transmission times, if there are conflicting transmission times. Priority values, and number of transmissions, first-in-first-out methodologies, can be used to assign non-conflicting transmission times. After assigning non-conflicting transmission times the process continues to step 360. If no transmission specific data is to be broadcast then the process continues from decisional step 345 to step 360 where Audio/Video Output Device 114 begins playing the audio-video segment. Process step 360 activates Audio/Video Output Device 114. The preferred playing device is that of a DVD player/recorder with Universal Serial Bus (USB) interface. Alternatively, Audio/Video Output Device 114 is a CD-ROM player, a CD-ReWriteable player, a MPEG enabled multimedia computer, a videocassette player, a MP3 player, a cassette player and the like. After playing has begun, decisional step 365 determines if the audio-video segment is at the end of a playing sequence. If the audio-video segment is done playing, i.e., at the end of the audio-video segment duration of time, then the process continues to termination step 399 where the process is stopped. If decisional step 365 determines the audio-video segment is still playing then the process continues to step 370 where Synchronizer 108 gets the current time from clock 122. Next decisional step 375 determines if digital signature 200 is scheduled for output to a digital distributing device, preferably transmitter 160. If digital signature 200 is scheduled for output then the process continues again to decisional step 365. If digital signature 200 (BOBBY) is scheduled for output then decisional step 380 determines if digital signature 200 (BOBBY) conflicts with any dynamically generated real-time broadcast digital signatures, i.e. two BOBBYs scheduled for the same time of transmission or having an overlap time. If a transmission time conflict exist between digital signatures, then the process continues to step 385 where a digital signature with the Lower priority is moved to a next available time slot for transmission. In the case of a tie, the preferred embodiment is a first-in-first-out methodology to resolve ties. Pluralities of methodologies exist for resolving ties which does not depart from the scope and spirit of the invention. After resolving conflicts in step 385 the process continues to step 390. If there are no conflicts as determined in decisional step 380, then the process again continues to step 390 where digital signature 200 is encoded for output. After being encoded, the process continues to step 395 where digital signature 200 is outputted to a digital distributing device, preferably transmitter 160. It should be noted that Analog Signal Generator 118 generates the analog signal associated with the audio-video segment concurrently with step 395. Alternatively, the audio-video segment generated by Analog Signal Generator 118 can be generated digitally using Digital Signal Generator 116. The process continues once again to decisional step 365 where again a determination is made on if the audio-video segment is finished playing. As previously described, if the audio-video segment is finished playing the process continues to termination step 399 where the process stops.

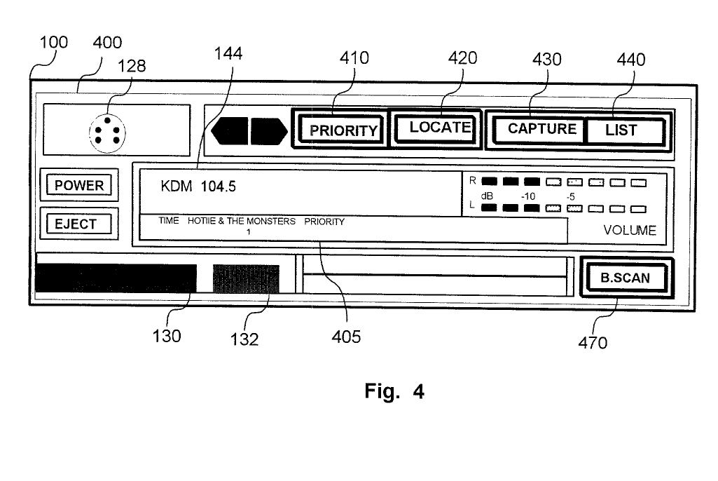

Turning now to FIG. 4, illustrated is a block diagram of one embodiment of an electronic user interface for capturing digital signatures and creating conditional preferences in accordance to the principles of the present invention. An electronic user interface 400 for receiver 100 receives transmitted instances of digital signatures and audio-video segments.

Electronic user interface 400 comprises a display unit 144 and a Capture button 430 for capturing a currently received digital signature from within onboard cache memory 146. In the preferred embodiment a transmission instance of digital signature 200 is retrieved from onboard cache memory 146. A textual description 405 of digital signature 200 is displayed in display unit 144. Also electronic user interface 400 provides means for displaying a list of previously captured digital signatures using a LIST button 440 in display unit 144. Electronic user interface 440 also provides means for designating a currently active digital signature from the list of previously captured digital signatures using List Button 440.

To receive digital signatures from infrared equipped device 138, wherein the infrared equipped device 138 is functioning as an infrared transmitter, electronic user interface 400 comprises IrDA Receiver/Sending Unit 132 as described in FIG. 1 and shown pictorially in FIG. 4. IrDA Sending/Receiving Unit 132 provides infrared sending and receiving means to receiver 100. ICC interface unit 130 of FIG. 4, shown also in FIG. 1, is attached to the electronic user interface 400 for card insertions to transfer digital signatures to receiver 100. Also comprising electronic user interface 400 is a Locate button 420 having the means of graphically interpolating a display of directions and geographical locations from GPS interface unit 128 (shown in FIG. 1 and FIG. 4) and a digital signature containing geographical coordinates. Further comprising electronic user interface 400 is Priority button 410 for allowing a user to select an interrupt-priority value for a selected digital signature. Still further comprising the electronic user interface 400 is a BOBBY scan button 470 enabling activation of scanner 152 to scan multiple frequencies for a subsequent transmission instance of digital signature 200. At least a first captured digital signature from the transmission instance of digital signature 200 is derived from activating Capture button 430 or as retrieved from IC Card 136 or from IrDA Sending/Receiving Unit 132 being communicatively coupled to infrared equipped device 138. IrDA Sending/Receiving Unit 132 detects an infrared signal from infrared equipped device 138 for communicatively coupling receiver 100 with another infrared equipped device 138. IrDA Sending/Receiving Unit 132 accepts transmitted conditional preferences as input from infrared equipped devices into receiver 100. ICC interface unit 130 detects an IC Card 136 (smart card) from insertion into ICC interface unit 130 for transferring digitally represented conditional preferences as input into receiver 100.

In an audio centric embodiment example, a user while listening to receiver 100 upon hearing a preferred audio-video segment presses Capture button 430 to secure a first captured digital signature. A user would either accept the default interrupt-priority value or assign a different interrupt-priority value using Priority button 410 thus creating a conditional preference, i.e., an audio-video segment with an associated interrupt-priority value. Subsequently, BOBBY Scan Button 470 enables receiver 100 to scan frequencies and mediums to actively seek at a subsequent instance of the associated digital signature. Upon receiver 100 detecting a subsequent instance of digital signature 200 determines if the subsequent instance of digital signature 200 has a higher interrupt-priority value than the interrupt-priority value associated to the currently playing audio-video segment. If the transmission instance digital signature has the higher interrupt-priority value then tuner 164 is tuned to the frequency or Internet address of the transmission instance of digital signature 200 for playing by receiver 100. Alternatively, the current audio-video segment is being played from internal playing component 176, such as a CD-disk, DAT, cassette tape or MP3 file of receiver 100. Internal playing component 176 plays the currently playing audio-video segment assigning the currently active digital signature with the associated interrupt-priority value. In this alternative embodiment, receiver 100 still actively seeks out frequencies and mediums comprising a transmission instance of digital signature 200 to substitute the currently playing audio-video segment by internal playing component 176 with an audio-video segment having the higher interrupt-priority value.

In a video centric embodiment of the present invention, electronic user interface 400 captures a digital signature correlated to a video segment of the broadcast program. Electronic user interface 400 is not limited to audio correlation of digital signatures and can be applied to other receivers other than receiver 100. Additional user interfaces for the management and manipulation of received digital signatures can be performed without departing from the scope of the invention.

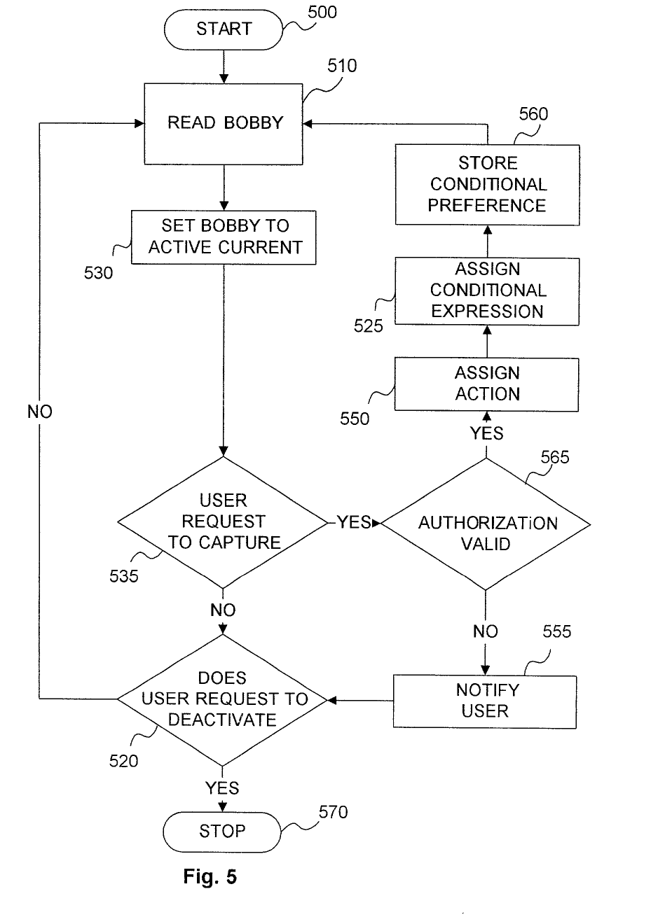

Turning now to FIG. 5, illustrated is a flow diagram for the method of associating a captured digital signature to a conditional preference. The process starts at step 500 where memory initialization and clearing of registers occur for the capture of a digital signature, preferably receiver 100 resets for reception of the composite modulated/digital signal transmission. Next process step 510 reads the transmission instance of digital signature 200 (BOBBY), preferably being transmitted by transmitter 160 and subsequently received from Digital BOBBY Decoder 154. Next process step 530 designates the transmission instance of digital signature 200 (BOBBY) as a currently active digital signature with a currently playing audio-video segment. Preferably, designated in onboard cache memory 146 and optionally displays on display unit 144 with an associated descriptive text. The process continues to decisional step 535 where a user, preferably by selecting Capture Button 430, request to capture the currently active digital signature creating at least a first captured digital signature having the correlated audio-video segment. If there is a request to capture the currently active digital signature (BOBBY), the process flows from 535 to where process step 565 determines authorization for at least the first captured digital signature (BOBBY). The currently active digital signature may be of a subscriber specific nature thus only allowing specific subscribers to capture and process the currently active digital signature. If a user does not have proper authorization the process continues to process step 555 where a user is notified of a failure to capture. Next the process continues to decisional step 520 where a determination is made on if to deactivate the process of associating captured digital signatures to conditional preferences. If a user deactivates the process of associating captured digital signatures to conditional preferences the process continues to termination step 570 where the process terminates. If there is not a request for deactivation then the process flow returns to process step 510. Returning to decisional block 535 if there is no request to capture the currently active digital signature the process once again continues to decisional step 520. Returning to decisional step 565, upon valid authorization process step 550 next assigns the associated action for a conditional preference. It should be noted that multiple captured digital signatures could be associated to multiple conditional preferences. Next the process continues to step 525 where a conditional expression is defined for the conditional preference. Process step 525 further binds the conditional expression with the associated action to create a conditional preference associated to the captured digital signature, preferable a user accessing keypad control unit 148 defines the conditional preferences for the captured digital signature. For example, using UTC for Play 258, Audio Song Identifier 226, and Channel to Play 252, within the captured digital signature a user may request to be notified 15 seconds in advance on what channel a user can listen to a preferred song. Next the process continues to where step 560 stores the conditional preference into non-volatile memory 142. Process step 560 allows a user to subsequently load the conditional preference for activation. The process continues once again to process step 510.

Alternatively, digital signature 200 read in process step 510 is received from IrDA Sending/Receiving Unit 132 being communicatively coupled to infrared equipped device 138. Alternatively, digital signature 200 read in process step 510 is received from IC Card 136 transference of digital signature 200 to ICC interface unit 130. Alternatively digital signature 200 read in process step 510 can originate from internal playing component 176 such as a CD-disk player, DVD disk player, DAT player, computer disk drive, cassette tape or MP3 playing component. Alternatively a user can request to capture the currently active digital signature stores a reference of the correlated audio-video segment. Alternatively, a default action is in step 550 for the interrupt-priority value to be manually assigned using keypad control unit 148 or to automatically assign a default interrupt-priority value for the first captured digital signature. The default action of assigning an interrupt-priority value creates a conditional preference for automatically substituting a currently playing correlated audio-video segment with a correlated audio-video segment having a higher interrupt-priority value. Alternatively, during process step 550 a user can assign a negative interrupt-priority value for the first captured digital signature. The negative value indicates that a user's preference is not to hear or view the correlated audio-video segment. The invention will automatically seek and search for an alternative audio-video segment upon tuner 164 receiving a correlated audio-video segment associated with a negative interrupt-priority value. For example, a user may detest a particular a song, thus the invention automatically seek and searches for other songs upon a detested song actively being played or upon broadcaster a preparing to broadcast the detested song. Alternatively process step 560 stores the conditional preference into IC Card 136 by transference of the conditional preference from ICC interface unit 130. Alternatively process step 560 communicatively couples IrDA Sending/Receiving Unit 132 to infrared equipped device 138 for storing the conditional preference into infrared equipped device 138.

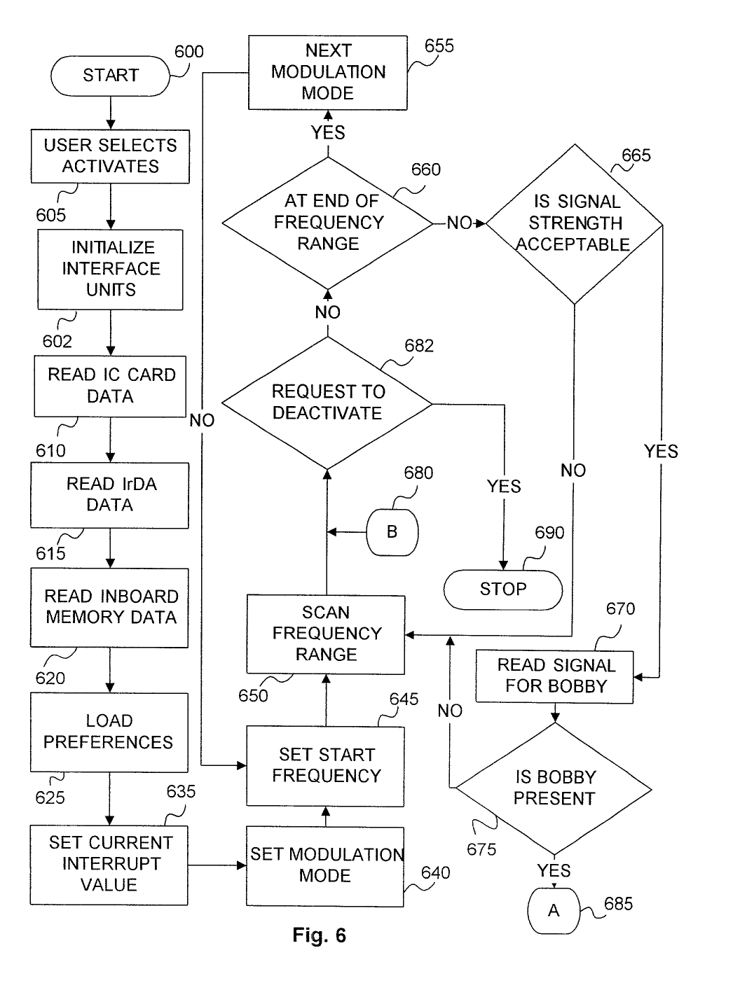

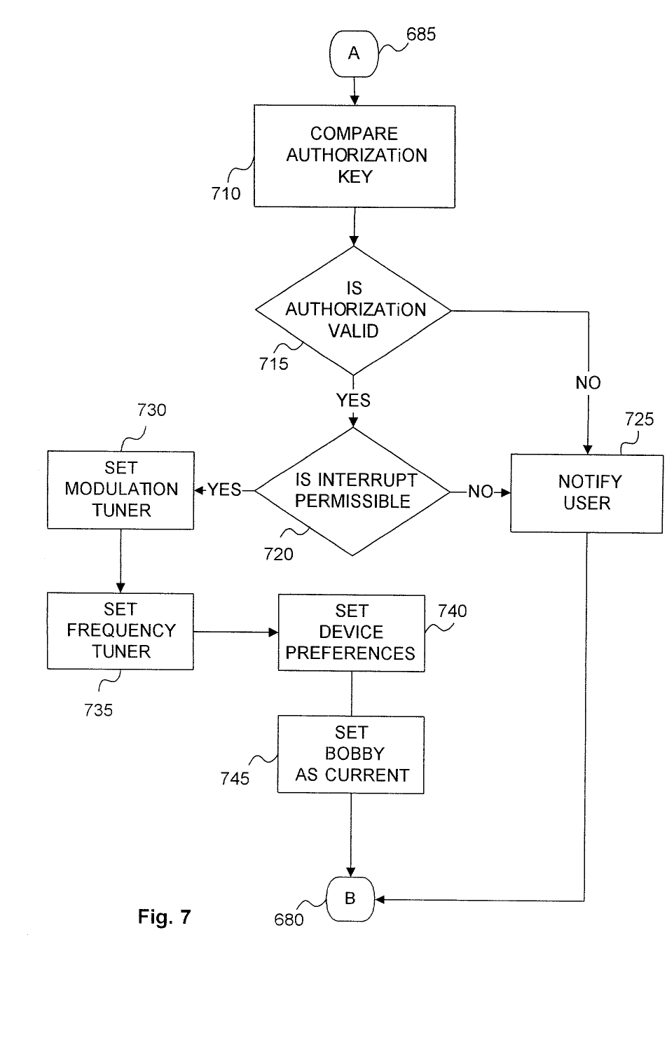

Referring now to FIGS. 6-7 are process diagrams illustrating the method of processing conditional preferences for substituting a currently playing audio-video segment. Referring specifically to FIG. 6 the process begins with start process 600 initializing scanner 152 and central processing unit 140. Next the process continues to process step 605 where a user selects to activate a conditional preference, the conditional preference is a default conditional preference, but that need not be the case. The default conditional preference will initiate program instructions for seeking frequencies and/or Internet addresses transmitting a subsequent instance of a captured digital signature having a correlated audio-video segment with a higher interrupt-priority value than the currently playing audio-video segment and automatically substituting the currently playing audio-video segment with the correlated audio-video segment having the higher interrupt-priority value. The default conditional preference contains at least a first captured instance of a digital signature for identifying the audio-video segment and an associated interrupt-priority value. Next process step 602 initializes and activates GPS interface unit 128, ICC interface unit 130 and IrDA Sending/Receiving Unit 132.

Next process step 610 reads at least one default conditional preference from ICC interface unit 130 if IC Card 136 is presently containing at least one default conditional preference. Next process step 615 reads at least one default conditional preference from IrDA Sending/Receiving Unit 132, if IrDA Sending/Receiving Unit 132 detects infrared equipped device 138 communicative coupling to receiver 100. Next process step 620 reads onboard cache memory 146, if at least one default conditional preference is present in onboard cache memory 146. Next process step 625 loads at least one default conditional preference for activation as was stored in process 560 of FIG. 5. Next during process step 635 identifies a current interrupt-priority value for the currently active digital signature associated with the currently playing audio-video segment, i.e. the current audio-video segment having an associated interrupt-priority value. If by happenstance, the currently active digital signature is also identified as a captured digital signature within a default conditional preference as loaded by process step 625 (i.e., a preferred audio-video segment is currently being played) then the current interrupt-priority value is set to a value as loaded in process step 625. If internal playing component 176 is active, i.e. the current audio-video segment is being played from internal playing component 176, then process step 635 sets the current interrupt-priority value to a value as defined for the audio-video segment being played by internal playing component 176. Next process step 640 assigns a current modulation mode, for example FM or AM. A default modulation mode can be user or system assigned. Next process step 645 sets a Start Frequency at which to start scanning multiple frequencies seeking a subsequent transmission instance of the captured digital signature as specified within the default conditional preference. Next step 650 scans a frequency range, preferably activating scanner 152 to scan the frequency range. Next decisional step 682 determines if there is a request to deactivate the processing of default conditional preferences. For example, selecting B-Scan button 470 again signals a request to deactivate the processing of conditional preferences. If there is a request to deactivate the processing of default conditional preferences then the process continues to termination step 690 where the process terminates. If there is not a request to deactivate processing of conditional preferences then decisional step 660 determines if the scanning of frequencies is at the end of the frequency range for the current modulation mode. If the scan frequency mode is at the end of the frequency range then the process continues where process step 655 selects a differing modulation mode. For example, receiver 100 may scan FM mode first then AM mode seeking subsequent transmission instances of captured digital signatures with associated conditional preferences. After step 655 the process once again continues at step 645 where the Start Frequency range is set for a next modulation mode. Returning to decisional step 660 if frequency scanning is not at the end of the frequency range then decisional step 665 determines if a selected frequency has acceptable signal strength. If the selected frequency is unacceptable for reception of then the process once again continues frequency scanning at process step 650. If the signal strength is acceptable the process continues from decisional step 665 to process step 670 attempts to read a transmission instance of a digital signature (BOBBY), preferable as decoded by Digital Bobby Decoder 154. Next decisional step 675 determines if the transmission instance of digital signature 200 (BOBBY) is a subsequent transmission instance of a captured digital signature as specified within at least one default conditional preference. If the transmission instance of digital signature 200 is not subsequent transmission instance of a captured digital signature as specified within at least one default conditional preference then once again the process continues to process step 650. Returning to decisional step 675, if the transmission instance of digital signature 200 is a subsequent transmission instance of a captured digital signature for at least one default conditional preference then the process resumes at continuation step A 685.

Referring now to FIG. 7, continuation step A 685 where the process continues to process step 710 where preferably an authorization key is compared on the subsequent transmission instance of the captured digital signature. Next the process continues where decisional step 715 determines authorization to receive the subsequent transmission instance of the captured digital signature. If a user is not authorized to receive the subsequent transmission instance of the captured digital signature then the process continues to process step 725 which notifies a user of denied authorization. Next the process continues to continuation step B 680. Referring again to FIG. 6, continuation step B 680 returns the process flow once again to decisional step 682. Returning to FIG. 7, if decisional step 715 determines authorization is valid to process the subsequent transmission instance of the captured digital signature then the process flows to where decisional step 720 determines if interrupting the current audio-video segment is acceptable. Decisional step 720 compares the current interrupt-priority value to the interrupt-priority value specified in at least one default conditional preference specifying the capture transmission instance of digital signature 200. It should be noted again that the current interrupt-priority value might have been derived from internal playing component 176 playing the current audio-video segment. If subsequent transmission instance of the captured digital signature as specified in the default conditional preference is less then or equal to the current interrupt-priority value, preferable stored in onboard cache memory 146, then the process continues to process step 725 which notifies a user of the subsequent transmission instance of the captured digital signature. This allows, for example, a user to manually select tuner 164 to the specified frequency, if desired, to play the audio-video segment associated to the subsequent transmission instance of digital signature 200 even though the transmission instance is of lower interrupt-priority value. Next the process once again continues to step B 680.

Returning to decisional step 720 if the subsequent transmission instance of digital signature 200 has a higher interrupt-priority value than the currently active digital signature, then process step 720 resolves the default conditional preference to a logically true state and alerts a user of an imminent substitution of the currently playing audio-video segment, thus permitting a manual override to avoid substitution of the currently playing audio-video segment. A default condition permits automatic substitution if a user does not respond by a specified time period. If a user does not manually override then the process continues to process step 730 which sets preferable tuner 164 to the modulation mode for the audio-video segment associated to the subsequent transmission instance of digital signature 200. Next the process continues to process step 735 where preferable tuner 164 is reassigned to the frequency of the subsequent transmission instance of the captured digital signature, for playing the associated audio-video segment. Next the process continues to step 740 where receiver specific attributes, such as volume, bass and treble are adjusted to the specified values as defined in field 250. This allows for specific songs to be played at specific volumes, bass, treble etc. through specific speakers. Next the process continues to step 745 where the transmission instance of the captured digital signature is specified as the currently active digital signature. Next the process once again continues to continuation step B 680.

Alternatively, process step 640 sequences a multiplicity of Internet addresses for seeking the transmission instance of the captured digital signature. Wherein process step 640 sequences a multiplicity of Internet addresses, process step 650 scans the multiplicity of Internet addresses and process step 655 starts rescanning the multiplicity of Internet addresses. Alternatively, tuner 164 maintains a network connection, tuner 164 in processes step 735 selects the corresponding Internet address associated with the transmission instance of the captured digital and associated streaming data.

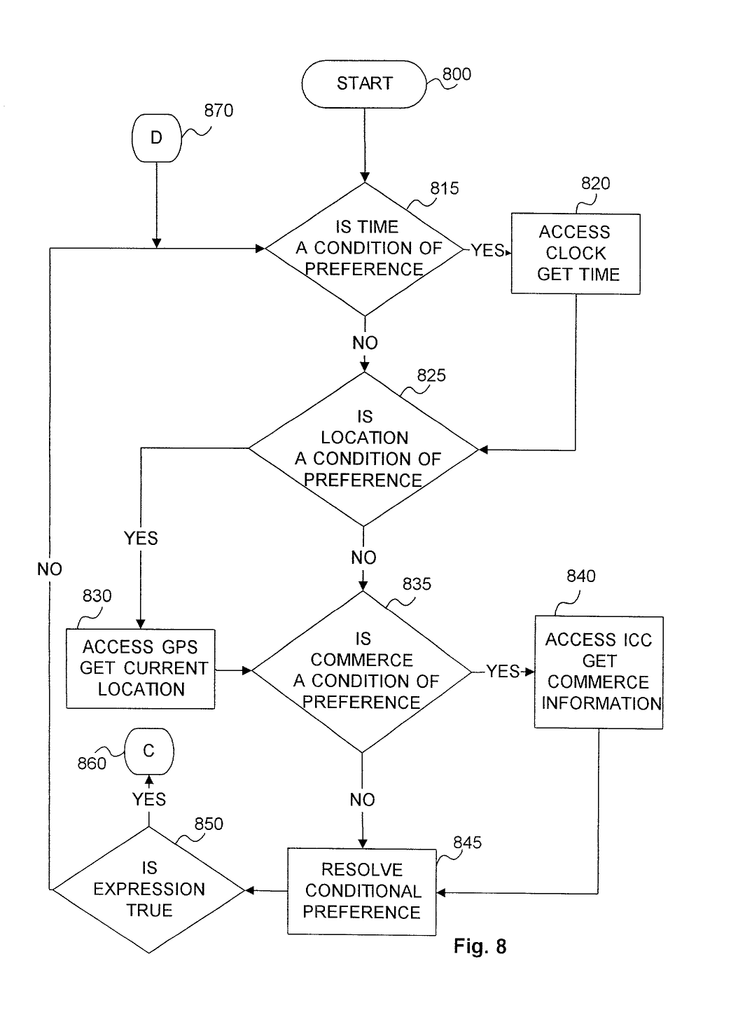

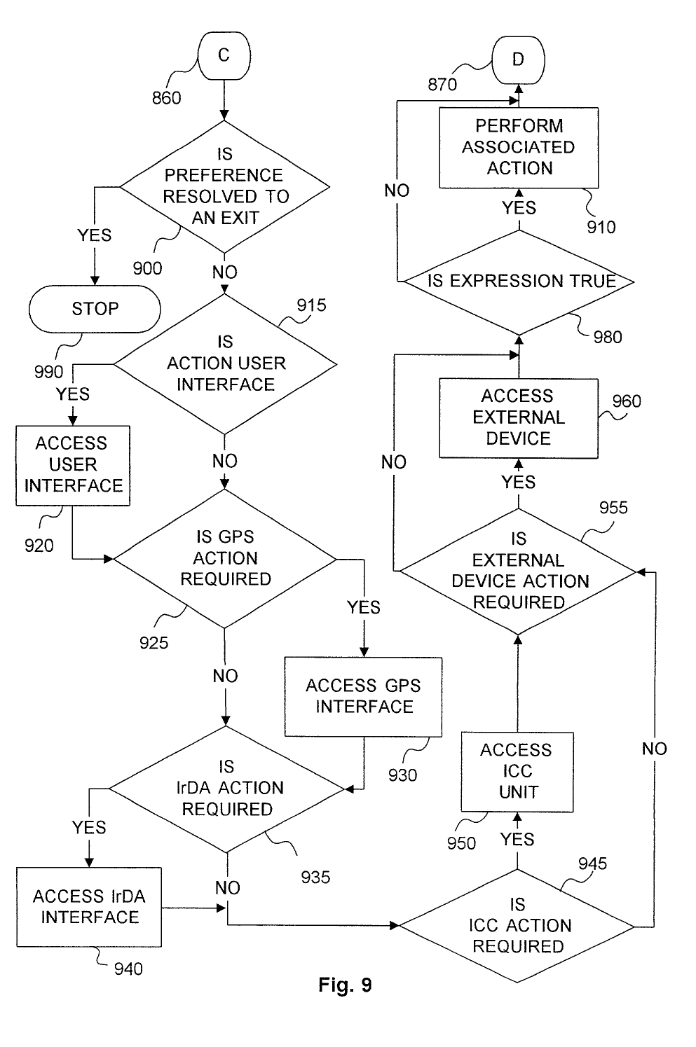

Referring now to FIGS. 8-9 are flow process diagrams illustrating automatic commercial, geographical and ancillary operations based on conditional preferences. Referring specifically to FIG. 8 the process begins in start process 800 where initialization occurs and conditional preferences have been loaded for activation (process steps 600-625). More specifically, start process 800 activates at least one conditional preference comprising of an active conditional expression and an associated action. Where multiple conditional preferences are desired for activation start process 800 loads and activates multiple conditional preferences. Next the process continues to decisional step 815 where the process determines if the active conditional expression has a time parameter and optionally to at least one transmission instance of digital signature 200. If the active conditional expression requires timing information then the process continues to process step 820 where preferably timing clock 156 is accessed for reading of a current time. From process step 820 the process continues to decisional step 825. Returning to decisional step 815 If the active conditional expression has no time parameter associated then the process continues to decision step 825 where a determination is made on if the active conditional expression has a geographical base parameter within the conditional expression and optionally to at least one transmission instance of a digital signature. For example, a user may wish automatic substitution of an audio-video segment with directions when a user is within a 5-mile radius of a specific store as reference in the transmission instance of digital signature 200. Thus the invention permits for Geographical Activated Event Advertising (GAEA), herein referred to as a GAFA system. If there is the geographical base parameter in the active conditional expression then the process continues to process step 830 where the processes receives geographical information from preferable from GPS receiver 134 via GPS interface unit 128. Alternatively, geographical information can be received from triangulation of cellular cells for a cellular device. Next the process continues to decision step 835. Returning to decision step 825 if no geographical base parameter exist then the process once again returns to decision step 835 where a determination is made on if a commerce parameter is associated to the active conditional expression and optionally to at least one transmission instance of a digital signature. For example, the active conditional expression may specify an item for sale as referenced in the transmitted digital signature that has a specific purchase price and acceptable credit rating for purchase of the item. If the commerce parameter exists then the process continues to process step 840, which access data from preferably IC Card 136 to collect associated commerce information necessary to execute a commerce transaction. Next the process continues to process step 845 wherein the time parameter, the geographical base parameter, the commerce parameter and optionally the transmission instance of a digital signature are resolved within the active conditional expression. Returning to decision step 835 if there is no commerce parameter associated to the active conditional expression then the process once again returns to step 845. Next the process continues to decision step 850 where a determination is made on if the active conditional expression evaluates to a logically true state. If the conditional preference evaluates to a false state then the process continues once again returns to step 815. It should be noted that a single conditional expression might contain a combination of time, geographical and commerce parameters, thus requiring multiple iterations as defined within FIG. 8. It should also be noted that the invention recognizes time, geographical, and commerce parameters as changing conditions, as well as newly received transmission instances of digital signature 200, thus reevaluating the active conditional expression as conditions change. If the active conditional expression evaluates to true then the process continues to continuation step C 860.

Referring now to FIG. 9, where the process continues from step C 860 to decision step 900 where a determination is made on if the active conditional expression evaluates to perform an exit action, for example to quit processing conditional preferences. If the resolution is to quit processing then the process continues to termination step 990 where the process terminates. Returning to decision step 900 if the active conditional expression is not evaluated to the exit action then process continues to determination step 915 which determines if the conditional preference requires a user interface action, for example, displaying information on a Liquid Crystal Display or making an associated audio sound. If the user interface action is required then process step 920 executes the user interface action. Next the process continues to decision step 925. Returning to decision step 915 if no user interface action is required then the process once again continues to decision step 925, which determines if the conditional expression requires geographical information, and/or for GPS interface unit 128 to be accessed. For example, geographical coordinates within a transmission instance of a digital signature may need to be displayed by sending GPS codes to GPS receiver 134. If the conditional preference requires GPS access then the process continues to where step 930 accesses GPS interface unit 128. In one conditional preference of the invention, at least one transmission instance of digital signature 200 comprising geographical coordinates is interpolated with geographical information from GPS interface unit 128 to display directions on display unit 144. In another conditional preference of the invention, at least one transmission instance of digital signature 200 comprising geographical coordinates is triangulated with geographical information from cellular cells.

Next the process continues to decision step 935. Returning to decision step 925 if the active conditional expression does not need access to GPS interface unit 128 then the process continues once again to decision step 935 which determines if an infrared action is associated with the active conditional expression. If an infrared action is associated with the active conditional expression then the process continues to step 940 which performs the associated infrared action via the IrDA sending/Receiving Unit 132. For example IrDA Sending/Receiving 132 may send infrared commands to infrared equipped device 138, which can be a radio, television, PDA, or a cellular phone. The process continues from 940 to decision step 945. Returning to decision step 935 if no infrared action is associated with the active conditional expression then the process once again continues to decision step 945 which determines if an ICC action is associated with the active conditional expression. For example, the conditional preference may request that data be save to IC Card 136. If no ICC action is required the process continues to decision step 955. Returning to decision step 945, if an ICC action is associated to the active conditional expression then the process continues to step 950 where ICC interface unit 130 is accessed to collect or write data to or from IC Card 136 to execute an electronic commerce transaction. Next the process continues where decision step 955 determines if an external device (not shown) is associated with the active conditional expression. The external device connection can be through output 170 or 172 of FIG. 1. In the preferred embodiment the interface is a Universal Serial Bus (USB) interface (not shown), alternative interface embodiments includes a serial or parallel port interface, not shown, connected to receiver 100. If no external action is required then the process continues to decisional step 980 where the active conditional expression is evaluated to a logical state of true or false. It should be noted that process step 820, 830, 940, 950, 960 permitted for collection of information from their respective devices to assist evaluating the logical state of the active conditional expression in decisional step 980. For example, process step 910 evaluates the active conditional expression requiring time information as received in process step 820 to determine if the logical state of the active conditional expression is true, essentially determining if it is time to perform the associated action for an internal or external device. If decisional step 980 determines the active conditional expression is false then the process continues to continuation step D 870.

Returning to decision step 955 if an external device action is associated with the active conditional expression the process continues to step 960 which access the external device with a specified set of commands as defined within the associated action. Next the process once again goes to decisional step 980. If the logical state of the active conditional expression is true then the process continues to 910 where actions are executed as specified within the associated action of the conditional preference and optionally relating to a transmission instance of digital signature 200. Once again the process continues to continuation step D 870 which continues the process again on FIG. 8 to determination step 815.

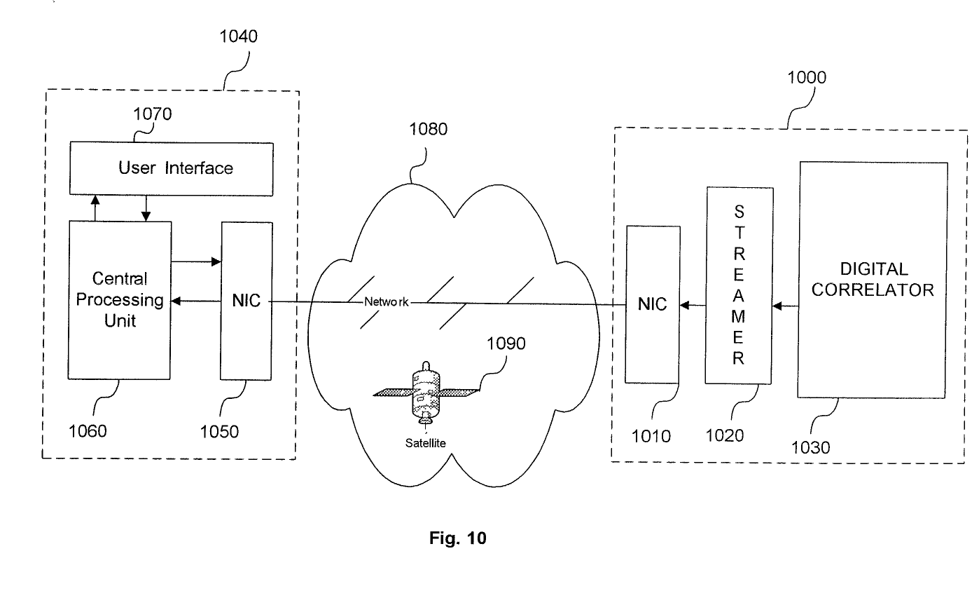

Turning now to FIG. 10 illustrating a block schematic diagram of an alternative embodiment of the invention comprising a distributed computer network as the transmission medium with a first computer 1000 functioning as the digital distributing device 160 and a second computer 1040 functioning as receiver 100. First computer 1000 correlates at least one digital signature to a data stream, such as audio or video multicasting. First computer 1000 may exist as traditional server within a computer network such as the Internet. First computer 1000 comprising of a Digital Correlator 1030 software component, performs a software application-processing equivalent of Digital Correlator 150 wherein synchronizing data casting of digital signature 200 to an audio-video segment duration of time, however the output is formatted and transmitted over the distributed computer network 1080, preferably using a Real-Time Streaming Protocol (RTSP), however, RTP, SMRP and RTCP are applicable to the invention. Digital Correlator 1030 software component concurrently sends an audio-video source and digital signature 200 to a Streamer Module 1020. The data is sent to a Network Interface Card (NIC) 1010 for transmission over the distributed computer network 1080. Distributed computer network 1080 in addition to wire and optical mediums may consist of a satellite 1090 for transmitting the streaming audio, video, and digital signatures through network 1080. At least one second computer 1040 having digital processing capability and a Network Interface Card 1050 for interfacing to the Computer Network 1080 decodes the data stream along with the set of digital signatures from the streaming audio or video source. Network Interface Card 1080 retrieves the data stream and digital signature 200 from the distributed computer network 1080 sending digital signature 200 to a programmable Central Processing Unit 1060 having means to secure a captured instance of digital signature 200 and associating the captured instance of digital signature 200 to at least one conditional preference. Central processing Unit 1060 has further instructions for detecting a subsequent instance of the captured digital signature for automatically executing the associated action of the conditional expression evaluating to true state.

Second computer 1040 has means for displaying a textual representation digital signature 200 having a correlated audio-video segment on video display 1095 and automatically selecting differing data streams being transmitted within the distributed computer network having a subsequent instance of the transmitted instance of digital signature 200 as described in FIGS. 3, and 5-9 with other improvements as described in these FIGURES as well. Alternatively, Streamer Module 1020 stores digital signature 200 in a database for the audio-video segment duration of time. In this alternative embodiment, the first computer 1000 can access digital signature 200 over distributed computer network 1080 within the duration of the audio-video segment duration time, optionally the data base may maintain digital signature 200 for a time longer than the audio-video segment duration of time due to network access and delayed timing characteristics. Alternatively, digital signature 200 may be streamed on separate channel than the audio-video source.

The invention claimed is:

1. A wireless receiver having equipment for receiving and detecting at least one transmission instance of a digital signature having a correlated audio-video segment for processing by a central processing unit with programmable stored instructions including the steps of:
determining if said transmission instance of said digital signature has at least one conditional preference comprised of at least one conditional expression and an associated action;
automatically initiating execution of said associated action upon said conditional expression evaluating to a logically true state.

2. A receiver as claimed in claim 1 further comprising an electronic user interface comprising a function control for associating at least a first captured digital signature and an associated interrupt priority for a currently active digital signature to said conditional preference.

3. A receiver as claimed in claim 1 wherein said central processing unit with programmable stored instructions further including the steps of:
seeking a correlated audio-video segment having a higher interrupt-priority value higher than said currently playing audio-video segment;
automatically substituting said currently playing audio-video segment with said correlated audio-video segment having said higher interrupt-priority higher value.

4. A receiver as claimed in claim 3, wherein said currently playing audio-video segment and associated interrupt-priority value are derived from an internal playing component.

5. A receiver as claimed in claim 4, wherein said internal playing component is a disk player.

6. A receiver as claimed in claim 1 wherein said receiver is a mobile radio.

7. A receiver as claimed in claim 1 wherein said receiver is a television.

8. A receiver as claimed in claim 1 wherein said receiver is a cellular phone.

9. A receiver as claimed in claim 1 wherein said conditional preference is transferred bi-directionally between said receiver and a smart card.

10. A receiver as claimed in claim 1 wherein said conditional preference is transferred bi-directionally between said receiver and an infrared equipped device.

11. A receiver as claimed in claimed 2 further providing means for interpolating geographical information from a GPS interface unit and geographical coordinates identified by said currently active digital signature for displaying geographical locations and directions within said electronic user interface.

12. A receiver as claimed in claim 13 wherein geographical information is received from triangulation of cellular cells for a cellular device.

13. A receiver as claimed in claim 1 further including the step of assigning multiple conditional preferences to said digital signature.

14. A receiver as claimed in claimed 1, wherein said associated action of said conditional preference is communicatively coupled between said receiver and an infrared equipped device.

15. A receiver as claimed in claimed 1, further including the step of determining to automatically initiate a seek and search for an alternative audio-video segment upon said receiver receiving said audio-video segment having an associated negative interrupt-priority value.

16. A Digital Correlator with digital and analog processing capabilities having a language decoder correlating the output of at least one digital signature to an audio-video segment duration of time; comprising:
a Synchronizer receiving timing information from a timing device to determine a non-conflicting transmission time for said digital signature within said audio-video segment duration of time;
said Synchronizer with means for outputting said digital signature to a digital distributing device within said audio-video segment duration of time;

17. A Digital Correlator as claimed in claim 16 wherein the language decoder is an Extended Broadcast Language Decoder.

18. A Digital Correlator as claimed in claim 16 wherein the language decoder is a Transmission Specific Signature Syntax Builder further comprising the steps of:
dynamically outputting a real-time broadcast digital signature for said Synchronizer;
said Synchronizer determines a non-conflicting transmission time for the real-time broadcast digital signature within said audio-video segment duration of time.

19. A Digital Correlator as claimed in claim 16 wherein the digital distributing device is a transmitter.

20. A Digital Correlator as claimed in claim 16 wherein the digital distributing device is a CD-ReWriteable device.

21. A Digital Correlator as claimed in claim 16 wherein the timing device is said audio-video output device sending a start signal and stop signal to said Synchronizer.

22. A Digital Correlator as claimed in claim 16 further including the step of determining a set of non-conflicting transmission times for continuously repeating transmission of said digital signature within the context of the broadcast program.

23. A transmitter having equipment for transmitting on a transmission medium at least one transmission instance of a digital signature correlated to at least one audio-video segment.

24. A transmitter as claimed in claimed 23 wherein said digital signature is transmitted on a separate transmission medium than the audio-video segment.

25. A transmitter as claimed in claim 23 wherein said digital signature identifies a song title.

26. A transmitter as claimed in claim 23 wherein said digital signature identifies an artist of a song.

27. A transmitter as claimed in claim 23 wherein said digital signature identifies a movie title.

28. A transmitter as claimed in claim 23 wherein said digital signature identifies a cast.

29. A transmitter as claimed in claim 23 wherein said digital signature identifies a channel to play.

30. A transmitter as claimed in claim 23 wherein said digital signature identifies a morality of play.

31. A transmitter as claimed in claim 23 wherein said digital signature identifies a UTC for play.

32. A transmitter as claimed in claim 23 wherein said digital signature identifies a critic identifier.

33. A transmitter as claimed in claim 23 wherein said digital signature identifies a critic rating.

34. A transmitter as claimed in claim 23 wherein said digital signature specifies electronic commerce information.

35. A transmitter as claimed in claim 23 wherein said digital signature identifies a commercial identifier.

36. A transmitter as claimed in claim 23 wherein said digital signature identifies a product code.

37. A transmitter as claimed in claim 23 wherein said digital signature identifies a product price.

38. A transmitter as claimed in claim 23 wherein said digital signature identifies a price to play.

39. A transmitter as claimed in claim 23 wherein said digital signature identifies a URL.

40. A transmitter as claimed in claim 23 wherein said digital signature identifies an interrupt-priority value.

41. A transmitter as claimed in claim 23 wherein said digital signature identifies a coupon identifier.

42. A transmitter as claimed in claim 23, wherein said digital signature identifies geographical coordinates.

43. A transmitter as claimed in claim 23, wherein said transmission medium is a television broadcast band.

44. A transmitter as claimed in claim 23, wherein said transmission medium is a distributed computer network.

45. A transmitter as claimed in claim 23, wherein said transmission medium is a Wireless Application Protocol medium.

46. A first computer having digital processing capabilities for transmitting at least one digital signature correlated to a data stream over a distributed computer network to at least second computer wherein said second computer having a central processing unit with programmable stored instructions including the steps of:
receiving said digital signature and said data stream;
associating at least one captured instance of said digital signature to a conditional preference comprised of at least one conditional expression and an associated action;
automatically initiating execution of said associated action upon said conditional expression evaluating to a logically true state.
